(19) United States
(12) Patent Application Publication
(10) Pub. No.: US 2026/0087832 A1
(43) Pub. Date: Mar. 26, 2026

(54) Method of duplicating a key for an opening from an image of this key

(71) Applicant: MINIT OPERATIONAL BOARD LIMITED, LONDON (GB)

(72) Inventors: Alexis DUMAINE, Epinay-sous-Sénart (FR); Colin BERNET, Monthieux (FR)

(73) Assignee: MINIT OPERATIONAL BOARD LIMITED, LONDON (GB)

(21) Appl. No.: 19/108,447

(22) PCT Filed: Sep. 6, 2023
(86) PCT No.: PCT/EP2023/074500

§ 371 Date: Mar. 4, 2025

(30) Foreign Application Priority Data
Sep. 7, 2022 (FR) FR2208938

(51) Int. Cl. G06V 20/66; G06T 5/73; G06T 7/194; G06V 10/82

(52) U.S. Cl. CPC G06V 20/66; G06T 5/73; G06T 7/194; G06V 10/82

(57) ABSTRACT

The invention relates to a method for duplicating a key for an opening from an image of this key, comprising the steps of determining: a) the type of key, b) the blank of the key, c) the cutting of the key, wherein steps a) and b) are performed by means of at least one deep learning algorithm.

The present invention relates to the field of duplicating keys for all types of openings.

In the context of the present invention, the openings can be, for example, doors or drawers.

For various reasons in everyday life, it is desirable to be able to copy a key: this makes it possible to have a duplicate, for example, if the original key is lost.

Until recently, copying a key required going to a locksmith who could make a true copy of the original key using conventional mechanical tools.

In order to simplify these processes, several solutions have been offered on the market to automate this classic key duplication process.

A common feature of these solutions is that they offer to start from an image of the key to be duplicated; this image can be taken, for example, with the camera of a mobile phone.

This image is then sent to a control center where it is analyzed to inform the customer whether the key falls within the category of keys that can be copied remotely.

If this is the case, after a quote has been approved by the customer-this quote is established manually and not immediately-the key is duplicated remotely and then sent to the customer.

An example of such a process is illustrated by patent application EP3992821.

In this patent application, the blank of the key to be reproduced, i.e. the key model before the cutting is performed, is determined from singularities marked on the original key, then using these singularities to select the appropriate blank from a blank database.

Although the process described in this patent application has certain advantages, such as reduced computing time, compared to other similar solutions, it is not entirely satisfactory in terms of the reliability and accuracy of copying the original keys. In addition, the customer has to wait a while before getting a quote, which lengthens the overall process time.

Thus, the present patent application aims in particular to improve the processes for duplicating keys from one or more images of the original key, in such a way as to enhance reliability and accuracy, and to reduce the overall duration of the time between the order by the customer and the delivery of their duplicate key.

This object of the invention, as well as other advantages that will appear in light of the description below, is achieved with a method for duplicating a key for an opening from at least one image of this key, comprising the steps of determining:
a) the type of key,
b) the blank of the key,
c) the cutting of the key,
   wherein steps a) and b) are performed by means of at least one deep learning algorithm.

By using such an artificial intelligence algorithm, errors made by the algorithm can be gradually corrected, making it more reliable and accurate, and reducing the overall process time.

Thanks to the method according to the invention, keys can thus be duplicated precisely and reliably, virtually without human intervention, which makes it possible to offer customers a highly competitive solution in terms of cost and time.

According to other optional features of the method according to the invention, taken alone or in combination:
said algorithm is of the deep convolutional neural network type: such an algorithm, known per se, is particularly suitable for the key duplication method;
the background of the image of the key is removed by means of a neural network algorithm: such an algorithm makes it possible to correct errors related to the presence of a background presenting a texture;
the orientation of the key with respect to the frame of the image is determined: this step increases reliability when analyzing the profile of the key;
the blur areas of the image of the key are reduced: this step also contributes to the increase in reliability;
the actual dimensions of the key are determined from the inter-piston distance of the associated lock: this step makes it possible to know the absolute distance between the pixels of the image of the key analyzed, and thus generate the information required to cut the key;
the shadow carried by the key is corrected: this correction step makes it possible to know the absolute width of the key blank, and thus generate the information required for cutting the key;
front and back views of at least part of the key are juxtaposed on the same image: this juxtaposition makes it possible to obtain maximum information on the key to be duplicated, from the analysis of a single image;
step b) is carried out by analyzing at least one particular area of the key: the analysis of this particular area makes it possible, on the one hand, to reduce the size of the image to be processed, and, on the other hand, to avoid polluting the artificial intelligence algorithm with information that may mislead it;
said analysis is performed from the first derivative of the curve of the profile of the key: this first derivative has proven to be a simple means of identifying characteristic points of the key profile;
said particular area comprises the junction area of the shank with the head of the key: this junction area has been shown to be characteristic of the various key blanks available on the market;
features of grooves of the key in said particular area are analyzed, these features being chosen from the group comprising the number of grooves, the positions of these grooves, the depths of these grooves, the shapes of the ends of these grooves.

The present invention also relates to a computer program product suitable for implementing the method in accordance with the above.

The present invention also relates to a key duplication system, comprising means for taking pictures of the key, means for analyzing the images thus obtained, means for determining the type of key and the blank, and means for cutting this blank, this system being controlled by a computer program in accordance with the above.

Other features and advantages of the invention will become apparent upon reading the following description, with reference to the appended figures, in which:

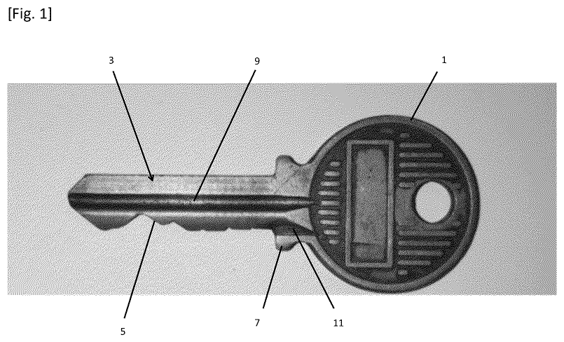

FIG. 1: shows a view of a flat key to be duplicated,

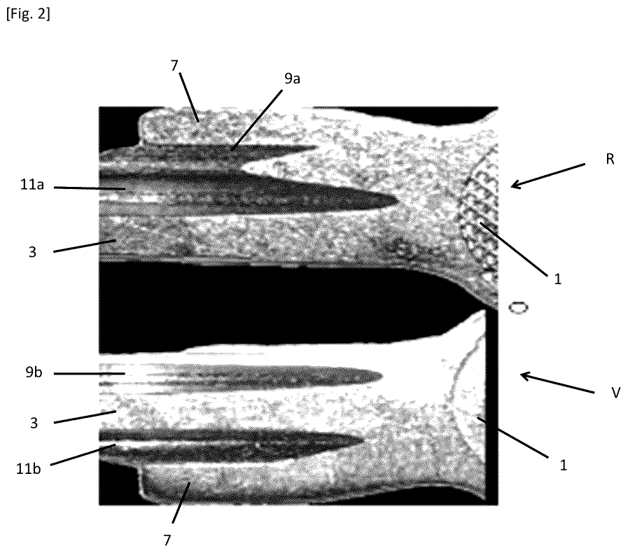

FIG. 2: shows juxtaposed front and back views of the junction area of the shank with the head of a flat key,

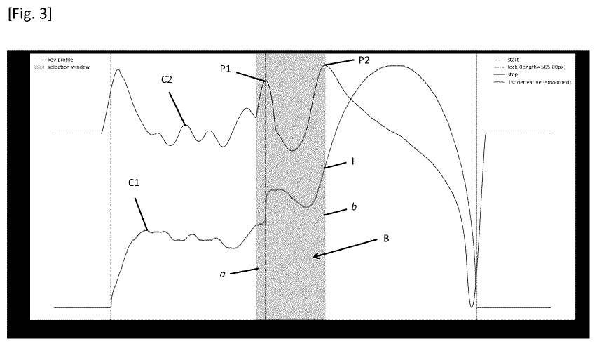

FIG. 3: shows the curve of the profile of a flat key to be duplicated, and the first derivative of this curve,

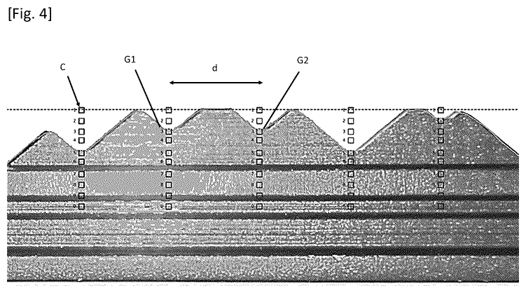

FIG. 4: the shaft of a flat key on which the different cutting depths corresponding to each of the pistons of an associated lock are highlighted.

For reasons of clarity, identical or similar elements bear identical or similar reference numerals in all the figures.

In the following, the invention will be described within the scope of the duplication of a flat key, but it should be understood that the principles of the invention are applicable to the duplication of any other type of key.

Reference is now made to FIG. 1, which shows a flat key to be duplicated.

Such a flat key comprises a head 1, a shank 3 on which a cut-out profile 5 is made, a stop 7, arranged in the connection region of the shank with the head, and longitudinal grooves 9, 11 extending over the length of the shank.

The head 1 of the key allows it to be gripped, the shank 3 of the key provided with its cut-out profile 5 and its grooves 9, 11 enables cooperation with the cylinder and with the pistons of a lock, and the stop 7 of the key enables the correct longitudinal positioning of the key, when it is inserted into the lock.

Such a key is so-called flat, in that the head 1, the shank 3, the cut-out profile 5 and the stop 7 are practically contained in one plane, unlike other keys on the market such as pump keys or grooved keys or wave keys (the latter being often used to open door locks of motor vehicles).

The object of the present invention is therefore to be able to duplicate such a flat key in a simple, automated, precise, reliable and fast manner.

This is done by first obtaining front and back images of the key to be duplicated: these images can be provided by the camera of a mobile phone of a user, or by an imaging device installed in a fixed kiosk, located for example in the vicinity of a supermarket.

Ideally, images of the key should be taken against an unstructured matte background, i.e. a plain background without texture.

In practice, this condition cannot always be met, so it is useful to use background suppression applications (segmentation), such as the one available on the https://remove.bg/fr platform, using a neural network algorithm.

In addition, algorithms known per se are used to correct the orientation of the key in relation to the edge of the image framing, as well as to absorb blur areas.

From the images obtained in this way, the type of key in question is first determined: for example, there are around 16 types of keys in Europe (flat, pump, grooved, wave, etc.).

This determination step is performed by means of an artificial intelligence algorithm, more specifically a deep convolutional neural network algorithm.

Such an algorithm, using a large number of images that have been previously validated, provides accurate and reliable results as to the type of key.

Once the type of key has been determined (flat, pump, grooved, wave, etc.), the next step is to determine the key model, i.e. the blank to be selected for cutting the appropriate profile.

The key blank to be copied is in fact a key without a cut-out profile, suitable for insertion into the same lock as the key to be copied, i.e. in particular provided with a shank whose dimensions (length, width) and shape (cross-section) allow this blank to be inserted into the associated lock.

In Europe, for example, there are more than 2,000 different blanks for flat keys.

In the method according to the present invention, a deep learning algorithm, preferably of the deep convolutional neural network type, is once again used to determine the appropriate key blank from the images of the key: unlike the prior art, a blank database is therefore not used that is interrogated by means of a characteristic descriptor of the key to be duplicated.

This deep learning algorithm can be gradually corrected by an operator to improve accuracy and reliability.

According to one option that proves particularly effective, the size of the image analyzed can be reduced to a particular area of the key.

More specifically, as can be seen in FIG. 2, the image analyzed may relate to the front R and back V faces of the junction area of the shank 3 with the head 1 of the key, where the stop 7 of this key is located.

Indeed, it became apparent that this junction area is quite characteristic of the key to be duplicated.

FIG. 3 shows the curve C1 of the profile of the key to be duplicated, as well as the curve of the first derivative C2 of this profile curve.

The curve of the first derivative C2 includes two characteristic peaks P1, P2 corresponding respectively to the position of the stop 7 of the key, and the inflection point I of the head of the key.

The position of these two peaks C1, C2 on the longitudinal axis of the key (x-axis in FIG. 3) makes it possible to define a band B on the key extending from a position a located slightly before the stop 7, to a position b corresponding to the inflection point I.

This band B corresponds to the area of the key in which the grooves 9a, 11a (front side) and 9b, 11b (rear side) of the key end, with a whole range of possible geometries for the end of these grooves, depending on the type of milling used: conical or pointed as shown for example in FIG. 2, or beveled, etc.

After reviewing the flat key models available on the market, it became apparent that, for both sides of the key, the number of grooves in the area of the band B, the positions of these grooves, the depths of these grooves, the shapes of the ends of these grooves, are characteristic information of each key model.

Thus, analyzing the image of both sides of the key in the area of the band B by means of a deep learning algorithm, preferably of the deep convolutional neural network type, makes it possible to achieve reliable segregation between the different flat key models.

It should be noted in particular that the fact of providing that the band B starts slightly before the stop 7 (part a of the band B in FIG. 3) makes it possible to provide a margin to cover the cases where the grooves 9, 11 would stop before this stop.

Once the blank of the key to be duplicated has been determined in this way, the parameters required for the physical cutting of the shank 5 of the key are determined.

For this, it is essential to know the actual dimensions of the key to be duplicated, i.e. the absolute distance between the pixels of the image of the key to be duplicated.

For this purpose, this image is calibrated from the distance d separating two successive grooves G1, G2, as shown in FIG. 4: this distance d, which corresponds to the distance separating two pistons of the associated lock, is indeed known for a given key blank.

To enhance precision, it is also possible to average all the distances between grooves to be duplicated from the key.

Another important parameter is the width of the shank 5 of the key to be duplicated, i.e. the width of the blank.

The determination of this width can be subject to errors due to shadows when imaging the key to be duplicated.

For this purpose, once the appropriate blank has been determined according to the preceding principles, the width of the shadow carried is deduced by difference: this makes it possible to precisely determine the depth of each groove to be cut on the blank, this depth being able to be expressed by a coding ranging, for example, from 1 to 10, as illustrated in FIG. 4.

Once the type of key, the model and the cut-out to be made on the blank have been determined, the customer can be sent an automated quotation for a duplicate key immediately, e.g. to their e-mail address.

Upon receipt of the customer's agreement on the quotation, from the key coding determined as indicated above, an automated machine supervised by an operator can cut the key profile in the shank of the blank.

Finishing (polishing) and testing operations can then complete this cut.

As will have been understood from the above, the method according to the invention allows a precise, reliable and fast automation of the process of reproducing a key, such as a flat key.

This method according to the invention can be implemented by an integrated machine comprising means for imaging the key, software means for implementing the steps described above, and means for cutting the key profile: in this case, the user places the key to be duplicated in the machine, and receives their duplicated key a few moments later.

Of course, a human-machine interface, such as a smartphone application, is provided, to ask the user questions (e.g. number of copies of the duplicate key to be produced), to submit a quotation, and to invoice the service.

Alternatively, the user can take pictures of the key to be duplicated themselves, for example using the camera of a mobile phone.

An application downloaded to this telephone can then allow these images to be sent to a remote server, on which the means of analysis and processing described above are implemented.

At the same site as this remote server, or at another site, an automated machine supervised by an operator, can cut the profile on the appropriate key blank, then send the duplicate key to the user by post.

Questions asked to the user on the machine and/or the intervention of an operator in the process of determining the type of key and the appropriate blank allow errors made by the deep learning algorithm to be gradually corrected, thus improving process accuracy and reliability over time.

Of course, the invention is described above by way of example. It is understood that a person skilled in the art is capable of creating various alternative embodiments of the invention without departing from the scope of the invention.

1. Method for duplicating a key for an opening from at least one image of this key, comprising the steps of determining: a) the type of key, b) the blank of the key, c) the cutting of the key, wherein steps a) and b) are performed by means of at least one deep learning algorithm.

2. Method according to claim 1, wherein said algorithm is of the deep convolutional neural network type.

3. Method according to claim 1, wherein the background of the image of the key is removed by means of a neural network algorithm.

4. Method according to claim 1, wherein the orientation of the key with respect to the frame of the image is determined.

5. Method according to claim 1, wherein the blur areas of the image of the key are reduced.

6. Method according to claim 1, wherein the actual dimensions of the key are determined from the inter-piston distance (d) of the associated lock.

7. Method according to claim 1, wherein the shadow carried by the key is corrected.

8. Method according to claim 1, wherein front and back views of at least part of the key are juxtaposed on the same image.

9. Method according to claim 1, wherein step b) is performed by analyzing at least one particular area of the key.

10. Method according to claim 9, wherein said analysis is performed from the first derivative (C2) of the curve (C1) of the profile (5) of the key.

11. Method according to claim 9, wherein said particular area comprises the junction area of the shank (5) with the head (1) of the key.

12. Method according to claim 11, wherein features of grooves of the key in said particular area are analyzed, these features being chosen from the group comprising the number of grooves, the positions of these grooves, the depths of these grooves, the shapes of the ends of these grooves.

13. Computer program product, suitable for implementing the method according to claim 1.

14. Key duplication system, comprising means for taking pictures of the key, means for analyzing the images thus obtained, means for determining the type of key and the blank, and means for cutting this blank, this system being controlled by a product according to claim 13.
